(19) United States
(12) Patent Application Publication
(10) Pub. No.: US 2004/0188197 A1
(43) Pub. Date: Sep. 30, 2004

(54) Piston plate for a magneto-rheological fluid damper

(76) Inventor: Ilya Lisenker, Miamisburg, OH (US)

Correspondence Address: Scott A. McBain, Delphi Technologies, Inc., Legal Staff - M/C 480-410-202, P.O. Box 5052, Troy, MI, 48007, US

(21) Appl. No.: 10/400,254

(22) Filed: Mar. 27, 2003

(51) Int. Cl. F16F 9/34; F16F 9/53

(52) U.S. Cl. 188/267.2; 188/322.15

(57) ABSTRACT

A piston plate for use with a magneto-rheological (“MR”) fluid damper. The piston plate comprises an inner hub and outer rim. The hub has simple geometry and is made from easily machineable material, permitting it to be fabricated using low-cost processes. The rim, which is secured over the hub, is made from a high strength, ferrous metal. The rim may be heat treated for greater strength and reduced magnetic permeability. In one embodiment of the present invention, the rim may be made from powdered metal. A magnetic insulator may be included on an interior face of the piston plate to reduce magnetic coupling between the rim and a piston core in a piston assembly. In another embodiment of the present invention, the piston plate may be made as a single piece from compressed powdered metal.

### TECHNICAL FIELD

The present invention relates to a piston plate for use with damping systems and, more particularly, to a piston plate for use with magneto-rheological damping systems.

### BACKGROUND OF THE INVENTION

Magneto-rheological dampers are becoming popular for a number of diverse uses. Examples include, but are not limited to, motion and position control devices, vibration and shock dampers, prosthetic devices, actuators, and seismic response reduction for structures.

Traditionally, dampers such as vehicle shock absorbers and struts have relied on the movement of a piston through a fluid-filled chamber wherein piston movement is resisted and controlled by mechanical valves that limit the amount of fluid that can flow past the piston. In more sophisticated systems, computer-controlled electromechanical valves are used to vary the flow rate. However, the valves and other associated small moving parts are subject to wear. In addition, the response time of electromechanical valves makes real-time control of damping difficult.

Magneto-rheological (“MR”) damping devices were developed to address the shortcomings of mechanical and electromechanical systems. MR damping devices utilize magneto-rheological fluid, which is named for rheology, the science dealing with the deformation and flow of matter. The flow characteristics of MR fluids are such that the viscosity of the fluids can be changed by several orders of magnitude within milliseconds when subjected to a suitable magnetic field. In general, MR dampers utilize an electromagnetic coil, which is installed in a piston of the damper. The piston is mounted on the end of a piston rod, the whole assembly being slideably disposed within a damper reservoir and separating said reservoir into compression and rebound chambers such that stroking the damper causes the MR fluid to flow from one of the aforementioned chambers to the other through a gap energizeable by an electromagnetic coil. An electronic control monitors the shock and vibration inputs and sends electrical commands to the electromagnetic coil to change the flow characteristics of the MR fluid by varying the coil's magnetic flux. Because the fluid can react quickly, the MR dampers react to input conditions much faster than mechanical and electro-mechanical systems, providing near real-time damping of vibration and shock inputs. An example MR fluid damper is taught by Muhlenkamp U.S. Pat. No. 6,260,675, incorporated herein by reference.

A first and second piston plate serve as end caps for the piston assembly of a damper. A piston rod is attached at one of the piston plates. In an MR fluid damper such as taught by Muhlenkamp, the piston plate may also provide mechanical attachment of a piston core to a piston ring of the piston assembly, preferably without providing a substantial ferromagnetic path that could shunt the magnetic flux around the energizeable gap. Furthermore, the piston plate may provide a reasonably unrestricted passage for MR fluid to reach the energizeable gap. It should be noted that the first and second piston plates typically are manufactured as a single piece and are typically identical in structure to permit interchangeability and reduce costs. The piston plates are also preferably made from a high strength material to withstand the high loads generated by damper operation. However, the complex geometries and features of the piston plates result in a high manufacturing cost for machined parts. Alternate manufacturing methods, such as investment casting and metal injection molding, do not appreciably reduce part cost due to the high cost of suitable raw materials. Further, parts produced by these methods require finish machining, adding cost.

Aluminum alloys typically are selected for piston plate material, due to aluminum's machineability and non-magnetic properties. However, aluminum has several limitations. First, its low fatigue strength makes the piston plate subject to early breakage in high load applications. In addition, aluminum is subject to erosion by the MR fluid, further reducing the life of the piston plate. Accordingly, there is a need for a piston plate for use with MR dampers that has lower cost and longer useful life.

### SUMMARY OF THE INVENTION

The present invention is a piston plate for use with MR dampers that has a relatively low cost, yet possesses a relatively long useful life. According to an embodiment of the present invention, the piston plate is two-piece, comprising an inner hub and an outer rim. The hub provides mechanical attachment of the piston assembly to the piston rod. The hub has simple geometry, facilitating fabrication by means of low-cost processes. The hub can be produced from inexpensive but strong non-magnetic materials, such as cold-drawn, austenitic stainless steel or a copper-based alloy selected for easiest machining. The rim, which fits over the hub, is made from a high-strength, ferrous metal and may be heat-treated for greater strength and reduced magnetic permeability. The present invention provides mechanical attachment of a piston core to a piston ring of the piston assembly without providing a substantial ferromagnetic path. In addition, the piston plate has reasonably unrestricted flow passages that permit MR fluid to reach the energizeable gap.

A magnetic insulator may be included on an interior face of the piston plate to further reduce magnetic coupling between the rim and a piston core in a piston assembly. In one embodiment of the present invention, the rim may be made from powdered metal. In another embodiment of the present invention, a piston core may include bypass passages to allow a portion of the MR fluid to bypass a flow gap of the piston assembly. In still another embodiment of the present invention, the piston plate may be made as a single piece from compressed powdered metal.

### SUMMARY OF THE DRAWINGS

Further features of the present invention will become apparent to those skilled in the art to which the present embodiments relate from reading the following specification and claims with reference to the accompanying drawings, in which:

FIG. 1 is a plan view of a two-piece piston plate according to an embodiment of the invention;

FIG. 2 is a central cross sectional view of the piston plate of FIG. 1;

FIG. 3 is a central cross-sectional view of a two-piece piston plate according to an alternate embodiment of the present invention; and

FIG. 4 is a central cross-sectional view of a two-piece piston plate and a piston core according to another embodiment of the present invention.

### DESCRIPTION OF THE PREFERRED EMBODIMENTS

In the description that follows, like parts are marked throughout the specification and drawings with the same reference numerals. The drawing figures are not to scale in the interest of clarity and conciseness.

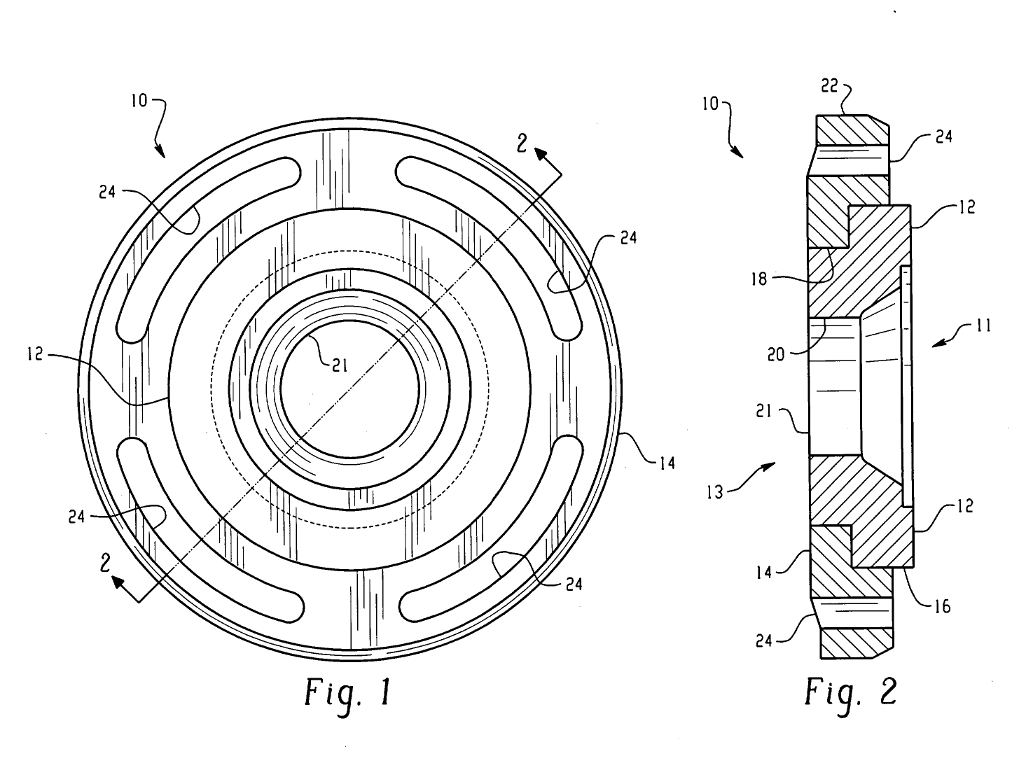

A piston plate for a magneto-rheological (“MR”) fluid damper according to the present invention, generally designated 10, is shown in FIGS. 1 and 2. The piston plate 10 includes a generally annular hub 12, which is inserted into a rim 14. The hub 12 and rim 14 may be secured together by any conventional means, such as a press-fit, adhesives, staking, welding, crimping, molding and fasteners. Together, hub 12 and rim 14 form an interior face 11 and exterior face 13 of the piston plate 10. Hub 12 is configured to have a simple, generally annular shape that can be quickly and inexpensively machined on equipment such as a lathe or computer numerically controlled (“CNC”) machine. Alternatively, the hub 12 may be cast or metal injection molded and then finish-machined, if needed.

An outer diameter 16 of the hub 12 is adapted to couple with an inner diameter 18 of a rim 14. An inner diameter 20 of the hub 12 forms a receptacle 21 adapted to couple with a piston rod of a piston assembly (not shown for clarity). Inexpensive, easily machineable, non-ferromagnetic materials are preferred for the hub 12. Examples include, but are not limited to, cold-drawn austenitic stainless steel, such as type 303 Se, or phosphor bronze, such as type CDA 544. These materials have high erosion resistance to MR fluids and a fatigue strength more than twice that of the aluminum alloys used in prior piston plates.

Rim 14 is generally annular in shape, having an inner diameter 18 and an outer diameter 22. The inner diameter 18 is adapted to couple with the outer diameter 16 of hub 12. The outer diameter 22 is adapted to couple with the piston assembly of the MR damper. Openings 24 in the rim serve as flow passages for the piston assembly. The rim 14 is preferably constructed from high strength ferrous metal. In one embodiment of the present invention, rim 14 is made of a suitable compressed ferrous powdered metal. In another embodiment of the present invention, the powdered metal may be admixed with a portion of nickel powder to create an austenite-containing structure to reduce the magnetic permeability of the rim for better compatibility with the electromagnetic coil (not shown) of the piston assembly. In yet another embodiment, the rim 14 may be heat treated to achieve higher fatigue strength and reduce magnetic permeability.

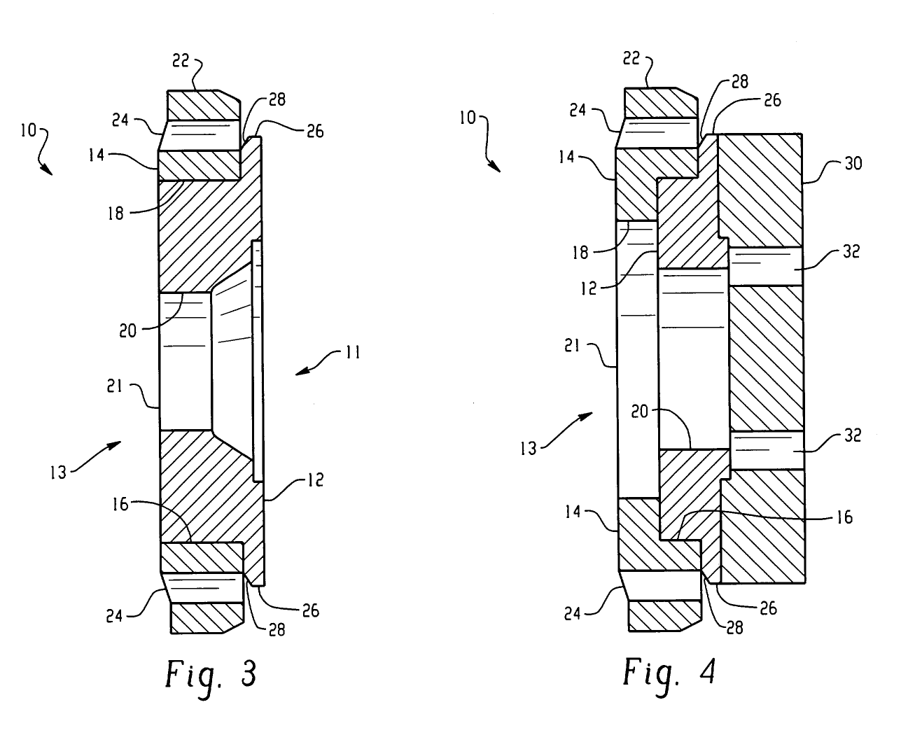

In an alternate embodiment, shown in FIGS. 3 and 4, an insulator 26 may be included to reduce coupling of magnetic flux between a piston core 30 of the piston assembly and the ferromagnetic rim 14. The insulator 26 may be a separate piece attached to the hub 12 and rim 14 by any convenient means to provide physical separation between the rim and piston core 30. Alternatively, the insulator 26 may be an integral feature machined or cast into the non-ferromagnetic hub 12. Further, the insulator may include a radius 28 to act as a funnel, reducing undesirable disruption of MR fluid flow at the flow passages 24 by streamlining and directing the flow of the fluid. The insulator 26 may provide a shoulder for the rim 14 to rest upon, simplifying the tooling for the rim and minimizing the volume of the rim while reducing the amount of material that must be removed from a machine blank to produce the hub 12.

In yet another embodiment of the present invention the piston plate 10 may be made as a single piece from a suitable compressed ferrous powdered metal. The powdered metal optionally may be admixed with a portion of nickel powder to create an austenite-containing structure to reduce the magnetic permeability. The single-piece embodiment of piston plate 10 also may be heat treated to achieve higher fatigue strength and reduce magnetic permeability. Further, the single-piece embodiment of piston plate 10 may include insulator 26 to reduce coupling of magnetic flux between the piston plate 10 and the piston core 30.

The piston assembly includes first and second piston plates 12, a first piston plate being positioned at a rod end of the assembly and a second plate 12 being positioned on the opposite end of the assembly. FIG. 4 illustrates the second piston plate 12 attached to a piston core 30. In an embodiment of the present invention, the piston core 30 may include bypass passages 32 to allow a portion of the MR fluid to bypass the flow gap (not shown) of the piston assembly. The bypass passages 32 are coupled to the receptacle 21 and positioned such that at least a portion of the MR fluid flows through the receptacle and the bypass passages. The amount of MR fluid bypass flow may be throttled by sizing the inner diameter 20 of the hub 12 such that a desired portion of the bypass passages are exposed to receptacle 21, the remaining portions of the passages being blocked by the hub 12. In this way the amount of bypass flow can be configured for a particular piston assembly by selecting low-cost, interchangeable piston plates 10 and piston cores 30 having the appropriate alignment of bypass passages 32 and receptacle 21 to achieve the amount of bypass flow desired. The hub 12 of the second piston plate 12 experiences only compression damping forces, being located on the end of the piston assembly opposite the piston rod. As a result, the hub 12 need not be made from high-strength materials. Acceptable materials include, but are not limited to, fine blanked or powdered metal stainless steel.

The various embodiments have been described in detail with respect to specific embodiments thereof, but it will be apparent that numerous variations and modifications are possible without departing from the spirit and scope of the embodiments as defined by the following claims.

1. For use with a magneto-rheological fluid damper, a piston plate comprising:
a) a generally annular, generally non-ferromagnetic hub having an outer diameter and a receptacle, the receptacle being adapted to couple to a piston rod;
b) a generally annular, ferromagnetic rim having at least one flow passage, an outer diameter adapted to couple with a piston assembly, and an inner diameter adapted to couple with the outer diameter of the hub; and
c) an interior face and an exterior face formed by coupling together the hub and the rim.

2. The piston plate of claim 1 further comprising a non-ferromagnetic insulator covering at least a portion of the interior face.

3. The piston plate of claim 2 wherein the insulator further comprises a radius adapted to act as a funnel for the flow passage.

4. The piston plate of claim 1 wherein the rim is made from compressed ferrous powdered metal.

5. The piston plate of claim 4 wherein the rim is heat treated.

6. The piston plate of claim 5 wherein the ferrous powdered metal further comprises nickel powder.

7. The piston plate of claim 1 wherein the receptacle is adapted to at least partially couple with at least one bypass passage of a piston core.

8. The piston plate of claim 1 wherein the hub is made from stainless steel.

9. The piston plate of claim 1 wherein the hub is made from phosphor bronze.

10. For use in a magneto-rheological fluid damper, a piston plate comprising:
a) a generally annular, non-ferromagnetic hub having an outer diameter and a receptacle, the receptacle being adapted to couple to a piston rod;
b) a generally annular, ferromagnetic rim having at least one flow passage, an outer diameter adapted to couple with a piston assembly, and an inner diameter adapted to couple with the outer diameter of the hub;
c) an interior face and an exterior face formed by coupling together the hub and the rim; and
d) a non-ferromagnetic insulator having a radius adapted to act as a funnel for the flow passage and covering at least a portion of the interior face.

11. For use in a magneto-rheological fluid damper, a piston plate comprising:
a) a generally annular, non-ferromagnetic hub having an outer diameter and a receptacle, the receptacle being adapted to couple to a piston rod;
b) a heat treated, generally annular, ferromagnetic rim made from a compressed ferrous powdered metal comprising nickel powder, the rim comprising at least one flow passage, an outer diameter adapted to couple with a piston assembly, and an inner diameter adapted to couple with the outer diameter of the hub; and
c) an interior face and an exterior face formed by coupling together the hub and the rim.

12. For use in a magneto-rheological fluid damper, a compressed powdered metal piston plate comprising:
a) a receptacle adapted to couple to a piston rod;
b) at least one flow passage;
c) an outer diameter adapted to couple with a piston assembly; and
d) a first, interior face and a second, exterior face.

13. The piston plate of claim 12 wherein the ferrous powdered metal further comprises nickel powder.

14. The piston plate of claim 12 wherein the piston plate is heat treated.

15. The piston plate of claim 12, further comprising a non-ferromagnetic insulator covering at least a portion of the interior face.

16. The piston plate of claim 15 wherein the insulator further comprises a radius adapted to act as a funnel for the flow passage.

17. A piston plate for a magneto-rheological fluid damper, the piston plate being made from compressed ferrous powdered metal comprising nickel powder and heat treated, comprising:
a) a receptacle adapted to couple to a piston rod;
b) at least one flow passage;
c) an outer diameter adapted to couple with a piston assembly; and
d) a first, interior face and a second, exterior face.

18. The piston plate of claim 17, further comprising a non-ferromagnetic insulator covering at least a portion of the interior face.

19. The piston plate of claim 18 wherein the insulator further comprises a radius adapted to act as a funnel for the flow passage.

20. For use in a vehicle magneto-rheological fluid damper, a piston plate comprising:
a) a generally annular, non-ferromagnetic hub having an outer diameter and a receptacle, the receptacle being adapted to couple to a piston rod;
b) a heat treated, generally annular, ferromagnetic rim made from a compressed ferrous powdered metal comprising nickel powder, the rim comprising at least one flow passage, an outer diameter adapted to couple with a piston assembly, and an inner diameter adapted to couple with the outer diameter of the hub;
c) an interior face and an exterior face formed by coupling together the hub and the rim; and
d) a non-ferromagnetic insulator having a radius adapted to act as a funnel for the flow passage and covering at least a portion of the interior face.

21. For use in a vehicle magneto-rheological fluid damper, a piston plate comprising:
a) a generally annular, non-ferromagnetic hub having an outer diameter and a receptacle, the receptacle being adapted to couple to a piston rod and to at least partially couple with at least one bypass passage of a piston core;
b) a generally annular, ferromagnetic rim having at least one flow passage, an outer diameter adapted to couple with a piston assembly, and an inner diameter adapted to couple with the outer diameter of the hub;
c) an interior face and an exterior face formed by coupling together the hub and the rim; and
d) a non-ferromagnetic insulator having a radius adapted to act as a funnel for the flow passage and covering at least a portion of the interior face.
